(19) United States
(12) Patent Application Publication
(10) Pub. No.: US 2014/0051043 A1
(43) Pub. Date: Feb. 20, 2014

(54) Method for behavioral modification

(71) Applicant: George Samuel Mosby, Annapolis, MD (US)

(72) Inventor: George Samuel Mosby, Annapolis, MD (US)

(21) Appl. No.: 13/573,055

(22) Filed: Aug. 17, 2012

(51) Int. Cl. G09B 19/00

(52) U.S. Cl. 434/236

(57) ABSTRACT

A method of modifying a person's behavior to cease that person's indulgence in undesirable behavior. Examples of such undesirable behavior would be smoking, drinking alcohol, and over-eating. The method involves modifying one's behavior by utilizing incentives to encourage certain behavior and disincentives to discourage certain behavior. As the person wishing to modify their behavior will be under the care of a physician, such a person is known as a “patient” under this method. One variation of the method requires that the patient place a predetermined amount of money into an escrow or lockbox account. A physician monitors the patient to determine if the patient is indulging in the undesirable behavior. If the patient is successful in avoiding such behavior, the patient is rewarded monetarily. If the patient is unsuccessful, the patient loses the money initially invested.

### FIELD OF THE INVENTION

The present invention relates generally to a method of modifying a person's behavior to cease their involvement in undesirable activities. More specifically, it relates to a method of aiding an individual in their quest to quit smoking.

### BACKGROUND OF THE INVENTION

Cigarette smoking, although common in today's society, has many disadvantages. The most obvious are the well-known health risks suffered by regular smokers and those around them (due to second-hand smoke). Health consequences include diminished pulmonary functioning, cardiovascular disease, cerebrovascular disease, and cancer of the lung, esophagus, head, neck and bladder. In addition, a smoking habit can be costly and can result in undesirable smells in an individual's hair and clothes. For these, and other, reasons, millions of people attempt to quite smoking every year. Many of these people are unsuccessful in quitting long-term, if at all. Therefore, there is a need for an effective method to assist those individuals in their quest.

Various techniques to aid people in their attempts to quit smoking are known. Conventional techniques frequently employ the use of only oral substitutes (e.g., gum, candy, artificial cigarettes) which are maintained in the person's mouth instead of a cigarette. The currently known techniques have various disadvantages. The most significant disadvantage is the dismal long-term prospects of success. The current relapse rate is approximately 93%.

Consequently, there is a need for a method to aid a person in their quest to quit smoking that does not depend on the use of only oral substitutes or other tangible things. Furthermore, there is a need for such a method that increases long-term success rates and decreases relapse rates for people attempting to quit smoking. A search of the prior art shows that no such method is known.

### SUMMARY OF THE INVENTION

It is a primary objective of the present invention to provide a method of modifying a person's behavior so that the person no longer indulges in undesirable behavior or activity.

It is another objective of the present invention to provide a method of smoking cessation to an individual who desires to quit smoking. More particularly, it is an objective of the present invention to provide a method of smoking cessation that doesn't require the use of only oral substitutes.

It is still another objective of the present invention to provide a method of modifying a person's behavior by using incentives and disincentives to adjust the person's behavior.

It is still another objective of the present invention to provide a method of modifying a person's behavior by using the possibility of gaining or losing money to influence the person's behavior.

### DETAILED DESCRIPTION OF THE PREFERRED EMBODIMENT

The method of the present invention employs what the inventor has named The Pass Line Method. “Pass Line” refers to the line bet position on a craps table upon which a bettor bets on his ability to make his point. As it relates to the present invention, “Pass Line” refers to the individual (who desires to quit smoking) betting on his ability to improve his or her health status by ceasing to smoke.

The method of the present invention is a specific four-phase sequential program for medically supervised and assisted smoking cessation. The four phases are: I) Motivation, II) Psychological Dehabituation, III) Detoxification, and IV) SIFROC Maintenance and Relapse Prevention. As the method of the present invention is medically supervised, the person desiring to quit smoking is henceforth referred to as a “patient.”

### Phase I: Motivation

Motivation to quit smoking is a key component of the method of the presnet invention. Ideally, the patient is motivated to quit smoking prior to seeking medical assistance with this method. Nicotene addiction is very strong. Motivation is critical because it would be essentially impossible for a nicotene-addicted individual to quit smoking if they didn't really desire such a result. Motivation can be reinforced and supported by a number of techniques. However, as part of the method of the present invention, the primary source of motivation is the patient's desire to live without the scourge of nicotene addiction.

### Phase II: Dehabituation

There are at least two intimately-linked essential components peculiar to a cigarette smoking habit: 1) Psychological habituation (and associated behaviors); and 2) nicotene addiction. Both of these components are difficult for a patient to overcome. Therefore, as part of the method of the present invention, each component is dealt with sequentially so as to break the link between them.

Psychological habituation is a phenomenon whereby a person responds to circumstances that trigger a desire for a cigarette. Examples would include post-consumatory behavior (e.g., eating and then automatically smoking after the meal or walking into bar to watch a game and automatically lighting a cigarette to smoke). Accordingly, psychological dehabituation is a cornerstone of the method of the present invention. The goal of psychological dehabituation is to disrupt the patient's tendency or routine of smoking as an associated behavior (e.g. subsequent to food or alcohol consumption).

Once the patient has succeeded in breaking the tendency or routine of indulging in smoking as an associated behavior, it is important to obviate the effect of nicotine withdrawal on the patient while the associated behavior (i.e., smoking) is extincted. This is achieved by providing pharmacologic nicotine support (e.g., nicotine patch, gum, etc.) to the patient. Other methods may also be used, such as: accupuncture, hypnotherapy, continued motivational support, or any other such method that is already well-known in the art.

### Phase III: Detoxification

Once the patient has been successful in breaking the habit of picking up a cigarette and smoking, the patient's addiction to nicotine can be addressed. To accomplish this, nicotine replacement is titrated down while other pharmacologic nicotine support (e.g., nicotine patch, gum, etc.) is given to the patient. Other methods of support may also be used, such as: accupuncture, hypnotherapy, continued motivational support, or any other such method that is already well-known in the art.

### Phase IV: SIFROC Maintenance and Relapse Prevention

Once the patient's nicotine habit and addiction have been addressed, altering the reward-punishment paradigm experienced by the patient is of utmost importance. A smoker's reward-punishment paradigm is as follows: The smoker receives positive reinforcement via stimulation of nicotinic receptors in the brain. If he or she attempts to quit smoking, the smoker received negative reinforcement via withdrawal symptoms. Therefore, the smoker's response is to continue to smoke, thereby gaining reward and avoiding punishment. In each scenario, the reward or punishment is immediate and strongly associated with the corresponding conditions.

Although the health consequences, previously discussed, are significant, they are all relatively latent effects and cannot compete on the reward-punishment battlefield with nicotine pharmacokinetics. Therefore, it is imperative to create (and the patient experience) an alternate pairing of reward and punishment. As such, smoking cessation is coupled to an alternate reward and smoking continuation is coupled to an alternate punishment. Accordingly, long-term smoking cessation can be achieved by adjusting the intensity and/or frequency of reward so as to compete with the level of addiction or habituation.

This is the fourth phase of treatment and is the most important regarding the prospects of the patient's long-term success. As such, the method of the present invention employs SIFROC: Self Imposed Financially Reinforced Operant Conditioning. SIFROC is a novel, unique, and proprietary therapeutic application of operant (i.e., patient) conditioning for smoking cessation. SIFROC can also be used for modification of other undesirable behavior.

Operant conditioning is a form behavior modification therapy. A patient's desired behavior becomes associated with reward and undesired behavior becomes associated with punishment. Using the method of the present invention, the patient's desire for money (especially his own) is placed in competition with his desire for a cigarette. At the beginning of the treatment, the patient remits a sum of money. The patient is monitored for a predetermined, finite amount of time. If the patient remains relapse-free (i.e., nicotine-free) for the duration of the predetermined, finite amount of time, the patient may request the originally remitted money. The patient may also remain in the program voluntarily so that the originally remitted money becomes interest-bearing. In the event that the patient relapses, the originally remitted money is forfeited.

Under this method, the operant's (i.e., patient's) positive response results in smoking avoidance and refusal. The operant stimulus is the positive reinforcement of the rebate of the originally remitted money plus the savings of cigarette expenditures. A negative response corresponds with a patient relapse. The stimulus is the negative reinforcement of the forfeiture of the originally remitted funds plus the cost of continued smoking.

In the event the patient experiences a relapse, he or she has a window of opportunity within which he or she can post an amount equal to the originally remitted amount, essentially betting himself “double or nothing” regarding his or her own will power. In doing so, the time period during which the patient is monitored also doubles. If the patient is successful (i.e., does not experience a relapse during the monitored time period), the patient receives all of the invested funds. Conversely, if the patient experiences another relapse, the patient can, remit an amount double the originally remitted amount and the time period for monitoring is extended even more. The patient can continue to self-wager “double or nothing” until success occurs (i.e., there is no relapse during the monitoring period).

Whether or not a patient receives a rebate is entirely based on their own behavior. This can be seen as stimulus or dose intensification. At some level of punishment or reward, the overwhelming majority of people will be sufficiently motivated to refrain from smoking once they have been dehabituated and detoxified.

The method of this invention may be structured so as to include some element of financial reward that is made incrementally during the monitoring period. Thus, the frequency of positive reinforcement is increased. However, punishment (via forfeiture of funds) as a result of relapse is conducted all at once. This provides sufficient immediacy to compete with the patient's urge to smoke.

In a preferred embodiment of the present invention, the patient is informed at the outset of the program that the enrollment fee (i.e., the originally remitted amount) is $1,850 due at registration. This is independent of the physician's office fee and must be paid out of pocket by the patient. It is critical that the fee not be paid by insurance, an employer, etc. Although, the fee can be set at a different amount, $1,850 is the approximate out of pocket cost to a patient who smokes one pack of cigarettes a day. The funds are deposited in any type of financial account or product suitable for maintaining such funds. Examples would include, but are not limited to, an escrow or lockbox account, as well as a perfomance bond. The patient is monitored for nicotine use by a physician for one year. If the patient is successful (i.e., does not indulge in the use of nicotine), the patient can request the initial investment of $1,850 after one year in the program. Alternatively, the patient can voluntarily remain in the program and continue to undergo monitoring while the invested funds bear interest. In the event that the patient relapses, the $1,850 investment is forfeited.

In a second embodiment of the present invention, the patient remits an enrollment fee (e.g., $1,850). Each month during the monitoring period, the patient must remit an additional amount. The additional amount is rebated back to the patient if the patient successfully completes that month (i.e., is nicotine-free). Each sucessive month, the additional amount increases. For example, the first additional amount could be $250, the second month it could be $500, the third month it could be $750, and so forth. By varying the amount at risk or available for rebate, stimulus intensity is adjustable. By varying the frequency of reward, stimulus frequency is adjustable.

In a third embodiment of the invention, the patient pays a higher enrollment fee (e.g., $3,500). For each month that the patient successfully abstains from nicotine, the patient receives $250. All principal funds would be rebated from the escrow account at the end of the monitoring period.

In a fourth embodiment of the present invention, the patient is potentially rewarded on a weekly basis with an escalating amount of money. Specifically, the patient receives a reward (i.e., rebate) for each successful week, through 52 weeks. The initial reward would be nominal (e.g., $1 or $2) then would escalate by the same amount or an accelerated increment.

While the preferred embodiment of the invention has been described, various alternative embodiments of the invention are possible without departing from the spirit and scope of the invention. For example, the method for behavioral modification may be constructed to modify other undesirable behaviors, such as, drinking alcohol or over-eating. Accordingly, the scope of the invention is not limited by the disclosure of the preferred embodiment.

1. A method of eliminating an individual's smoking habit and associated nicotene addiction, comprising the steps of:
establishing and reinforcing an individual's motivation to eliminate a smoking habit;
disrupting the individual's tendency or routine of smoking as an associated behavior;
obviating the effect of nicotine withdrawal on the individual while the associated behavior is extincted by providing pharmacologic nicotine support to the patient;
titrating down nicotene replacement while providing other pharmacologic nicotine support to the patient;
entering the individual into a program;
requiring the individual to remit a program enrollment fee;
maintaining said program enrollment fee in a financial account; and
conducting periodic monitoring activities of the individual for a program period to detect any indulgence in tobacco products by the individual;
returning the program enrollment fee to the individual and allowing the individual to terminate participation in the program if the periodic monitoring activities indicate that the individual has refrained from any indulgence in tobacco products during the entire program period; and
having the individual forfeit the program enrollment fee if the periodic monitoring activities indicate that the individual has not refrained from any indulgence in tobacco products during the program period;
wherein said periodic monitoring activities are conducted by a physician.

2. The method of claim 1, wherein the pharmacologic nicotine support may be a nicotine patch, gum, accupuncture, hypnotherapy, continued motivational support, or any other such method that is already well-known in the art.

3. The method of claim 2, wherein the financial account is chosen from the group consisting of an escrow account, lockbox account, and perfomance bond.

4. The method of claim 3, further comprising the step of:
requiring that the program enrollment fee be provided from the individual's own funds.

5. The method of claim 4, wherein the program enrollment fee is $1,850.

6. The method of claim 5, wherein the program period is one year.

7. The method of claim 6, further comprising the step of:
not returning the program enrollment fee to the individual and allowing the individual to continue to participate in the program if the periodic monitoring activities indicate that the individual has refrained from any indulgence in tobacco products during the program period.

8. The method of claim 1, further comprising the steps of:
requiring the individual to remit an additional fee each month during the program period;
returning the additional fee to the individual if the periodic monitoring activities indicate that the individual has refrained from any indulgence in tobacco products during that month; and
increasing the amount of the additional fee for each successive month.

9. The method of claim 4, wherein the program enrollment is greater than $1,850.

10. The method of claim 9, wherein the program enrollment is $3,500.

11. The method of claim 9 or claim 10, further comprising the step of:
returning $250 to the individual each month that the individual has refrained from any indulgence in tobacco products during the program period.

12. The method of claim 4, further comprising the step of:
returning to the individual an escalating amount of money on a weekly basis for each week the individual has refrained from any indulgence in tobacco products during the program period.

13. The method of claim 12, wherein an initial amount returned to the individual is nominal.

14. A method for modifying an individual's behavior so as to eliminate an undesirable habit, comprising the steps:
establishing and reinforcing an individual's motivation to eliminate an undesirable habit;
disrupting the individual's tendency or routine of engaging in the undesirable habit;
entering the individual into a program;
requiring the individual to remit a program enrollment fee;
maintaining said program enrollment fee in a financial account; and
conducting periodic monitoring activities of the individual for a program period to detect any indulgence in the undesirable habit;
returning the program enrollment fee to the individual and allowing the individual to terminate participation in the program if the periodic monitoring activities indicate that the individual has refrained from any indulgence in the undesirable habit during the entire program period; and
having the individual forfeit the program enrollment fee if the periodic monitoring activities indicate that the individual has not refrained from any indulgence in the undesirable habit during the program period;
wherein said periodic monitoring activities are conducted by a physician.

15. The method of claim 9, further comprising the step of:
returning $250 to the individual each month that the individual has refrained from any indulgence in tobacco products during the program period.

16. The method of claim 10, further comprising the step of:
returning $250 to the individual each month that the individual has refrained from any indulgence in tobacco products during the program period.
